(19) United States
(12) Patent Application Publication
(10) Pub. No.: US 2021/0323020 A1
(43) Pub. Date: Oct. 21, 2021

(54) Assembly to Extend the Height of a Popup Sprinkler Nozzle

(71) Applicant: Gary Penrod, Redlands, CA (US)

(72) Inventor: Gary Penrod, Redlands, CA (US)

(21) Appl. No.: 17/224,807

(22) Filed: Apr. 7, 2021

Related U.S. Application Data
(60) Provisional application No. 63/010,859, filed on Apr. 16, 2020.

(51) Int. Cl. B05B 15/656

(52) U.S. Cl. CPC B05B 15/656

(57) ABSTRACT

Disclosed herein is an assembly consisting of two cooperating components. The first component, referred to as a sleeve, is in the shape of a hollow cylinder having an inner surface and an outer surface. The sleeve has a threaded attachment means at its proximal end to be releasably attached to the sprinkler's housing and a similar threaded attachment means at its distal end to be releasably attached to the sprinkler's cap. Within the sleeve is a retaining ring, orientated about its proximal end, protruding inwardly about the circumference of the inner surface of the sleeve, the retaining ring acting as a stop for the sprinkler's internal spring and riser.

### CROSS-REFERENCE TO RELATED APPLICATIONS

This application claims priority from U.S. Provisional Patent Application No. 63/010,859 filed on Apr. 16, 2020. The entire disclosure of the prior application is considered to be part of the disclosure of the accompanying application and is hereby incorporated by reference.

### BACKGROUND OF THE INVENTION

### 1. Field of the Invention

The present invention relates to pop-up sprinkler devices found in irrigation systems, more particularly a spacer kit to fit between the housing and the cap of a sprinkler.

### 2. Description of the Related Art

Millions of homeowners and commercial properties utilize in-ground irrigation systems to provide regular watering of the grass and other landscape features disposed of on the property. These automated systems provide convenience and control over the times and amount of water discharged onto the property. Typically, these irrigation systems consist of a main line that is connected to the property's incoming water line, having branches to reach into portions of the property that require watering. The main line and branches are buried so as not to be an eyesore or obstacle and to prevent damage. From the main line and branches, as appropriate, a pop-up sprinkler is attached in such a way that the top of the pop-up sprinkler is level with the ground.

A pop-up sprinkler is comprised of a housing, a cap that screws on top of the housing, and a stem that slides through the housing and out the cap. Atop the stem is a nozzle that allows water, passing through the housing and stem, to be distributed about the sprinkler head. A spring within the housing keeps the stem retracted. When water pressure builds up within the housing, the spring compresses and the stem is extended beyond the cap.

Over time, the soil and grass thatch build up over and around the sprinkler. This buildup prevents the pop-up sprinkler from performing as intended as soil and grass may reach a height to obstruct the proper distribution of water about the sprinkler. The most common solution to this problem is to remove the soil and grass that have built up about the sprinkler, remove the sprinkler from the water line, install a longer extension tube between the sprinkler and the water line, attach the sprinkler to this extension tube, and then return the soil and grass that was removed. However, this is a time-consuming procedure.

US patent publication 2021/0053084 to Ketterling resolved this problem by disclosing a riser extension kit that elevates the riser of a pop-up sprinkler. The kit includes a gripping head having a channel extending therethrough, and a riser extension configured to slide within the channel and having a length corresponding to the length of the channel. The lower end of the gripping head is configured for attachment to the sprinkler's cap by a plurality of flexible pawls spaced evenly about the lower end, or alternatively to an upper portion of an identical gripping head. The riser extension includes means for attachment between the sprinkler head and the sprinkler riser. To elevate the sprinkler, the head is detached, the riser passes through the gripping head, the riser extension attached to the riser, the nozzle attached to the riser extension, and the gripping head attached to the top of the sprinkler. Gripping heads and riser extensions are stackable atop one another, to enable elevation of the sprinkler head in multiple stages. However, the plastic pawls of the gripping head, enabling the gripping head to snap onto a sprinkler's cap, may break over time or may become dislodged by the application of lateral forces.

U.S. Pat. No. 10,933,434 to Pfanstiehl discloses a sprinkler housing extension that is screwed onto the upper end of a sprinkler's housing after the cap is removed. The cap is then reinstalled on the extension to raise the effective height of the sprinkler's housing and its spray pattern. Although the Pfanstiehl extension uses thread mounts to attach itself to the sprinkler as opposed to pawls, the extension does require the installer to align the splines of the extension with the splines within the housing. Also, the Pfanstiehl extension requires that the installer use a set screw to ensure that the splines in the Pfanstiehl extension, after installation, do not become misaligned. If the set screw is not properly installed or becomes loose, the riser within the housing will fail to extend when water pressure is applied.

Based on the above, there exists a need for various improvements in the art of underground sprinkler systems. More specifically, there exists a need in the art for a sprinkler head extension assembly that can reliably and easily extend the distance between the cap and the housing without requiring excavation, complex mechanical adjustments, disassembly or complicated manipulations.

### BRIEF SUMMARY OF THE INVENTION

The disadvantages discussed above are overcome by an assembly disclosed herein. The assembly consists of two cooperating components: a first component in the shape of a hollow cylinder having an inner surface and an outer surface with a threaded attachment means at its proximal end to be releasably attached to the sprinkler's housing and a similar threaded attachment means at its distal end to be releasably attached to the sprinkler's cap and a second component also in the shape of a hollow cylinder with a threaded attachment means at its proximal end to be releasably attached to the sprinkler's riser and a similar threaded attachment means at its distal end to be releasably attached to the sprinkler's nozzle. Within the first component is a retaining ring protruding inwardly about the circumference of the inner surface, the retaining ring acting as a stop for the sprinkler's spring and riser.

To install, the installer must clear away soil and grass about the cap. The cap is then removed from the housing and the first component is threaded onto the housing. The nozzle is removed from the riser and the second component is threaded onto the riser and the nozzle is threaded onto the second component. To complete the installation the cap is threaded onto the first component. The installation is simple, quick, and reliable.

After the assembly has been installed the height of the riser is then extended by the length of the components so as to clear the growth of soil or grass about the sprinkler.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

Neither this summary nor the following detailed description defines or limits the invention. The invention is defined by the claims.

### BRIEF DESCRIPTION OF DRAWINGS

The present invention will become more fully understood from the detailed description and accompanying drawings. Other systems, methods, features, and advantages of the invention will be or will become apparent to one with skill in the art upon examination of the following figures and detailed description. It is intended that all such additional systems, methods, features, and advantages be included within this description, be within the scope of the invention, and be protected by the accompanying claims. Component parts shown in the drawings are not necessarily to scale and may be exaggerated to better illustrate the important features of the invention. Dimensions disclosed or shown are exemplary only. In the drawings, like reference numerals may designate like parts throughout the different views, wherein:

FIG. 1 shows a sprinkler head of the prior art properly installed to maximize water coverage.

FIG. 2 shows a sprinkler head of the prior art where, due to soil accumulation, the soil has overgrown the sprinkler head thus adversely impacting water coverage.

FIG. 3 shows a sprinkler head modified by the assembly disclosed herein thus extending the nozzle above the combination of the accumulated soil and grass.

FIG. 4 shows an exploded view of the sprinkler head of the prior art.

FIG. 5 shows an exploded view of the sprinkler head modified with the assembly disclosed herein.

FIG. 6 shows a sectional view of the sprinkler head of the prior art.

FIG. 7A shows a sectional view of the sprinkler head of the prior art extended with the assembly disclosed herein.

FIG. 7B shows a sectional view of the sprinkler head of the prior art extended with multiple assemblies of the type disclosed herein.

FIG. 8 shows an isometric sectional view of the sleeve of the assembly disclosed herein.

### DEFINITIONS

Spring constant is a characteristic of a spring which measures the ratio of the force affecting the spring to the displacement caused by it. In other words, it describes how stiff a spring is and how much it will stretch or compress. Springs with larger spring constants will have smaller displacements than springs with lesser spring constants for the same mass added.

### DETAILED DESCRIPTION OF THE INVENTION

The following description of the preferred embodiment(s) is merely exemplary in nature and is in no way intended to limit the invention, its application, or uses. The foregoing problems installing risers on existing pop-up sprinklers are overcome by the assembly disclosed herein. In one embodiment, the extension kit consists of two cooperating parts: an external sleeve and an internal riser extension.

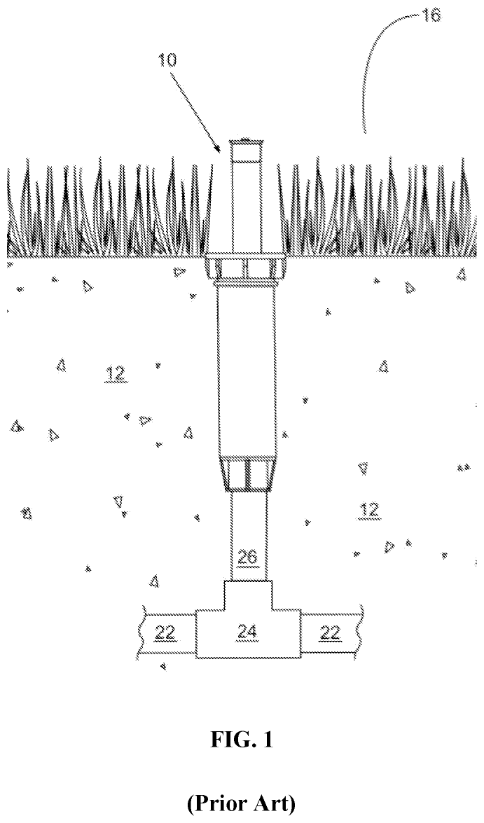

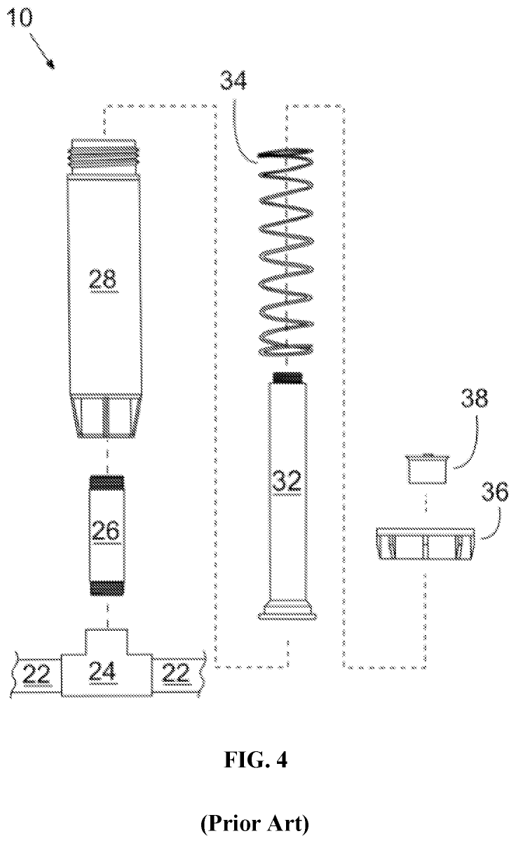

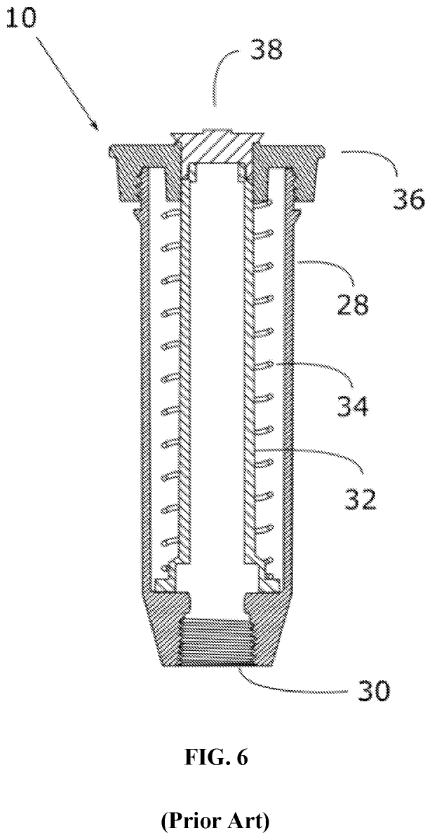

Broadly, FIG. 1 shows prior art sprinkler head 10 being fluidly interconnected to an underground irrigation line or system comprised of water line 22, tee junction 24, threaded riser 26, and at least partially mounted within soil 12 with the top of prior art sprinkler head 10 settled at the boundary of soil 12 and grass 16. FIG. 4 shows an exploded view of prior art sprinkler head 10 while FIG. 6 presents a sectional view of prior art sprinkler head 10. Prior art sprinkler head 10 may generally include housing 28 wherein riser 32 and spring 34 are found, cap 36, and nozzle 38.

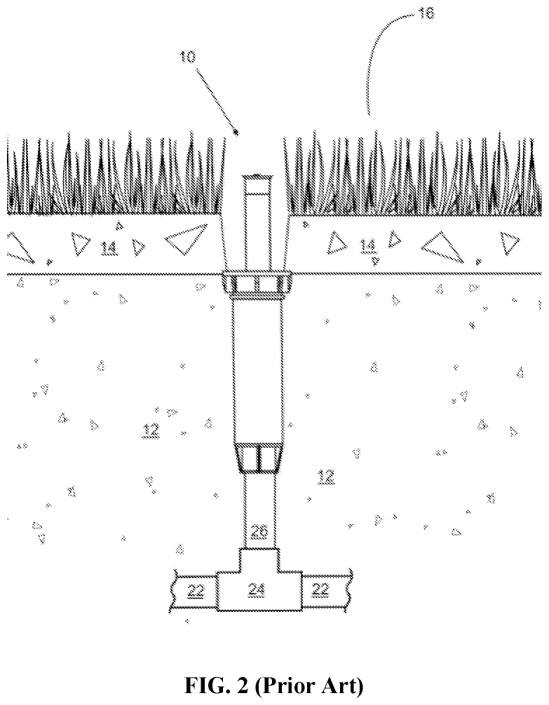

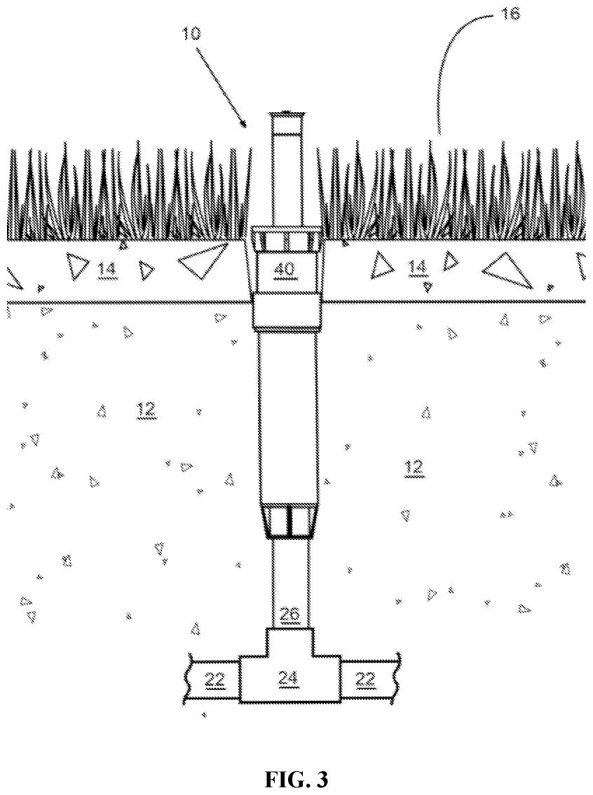

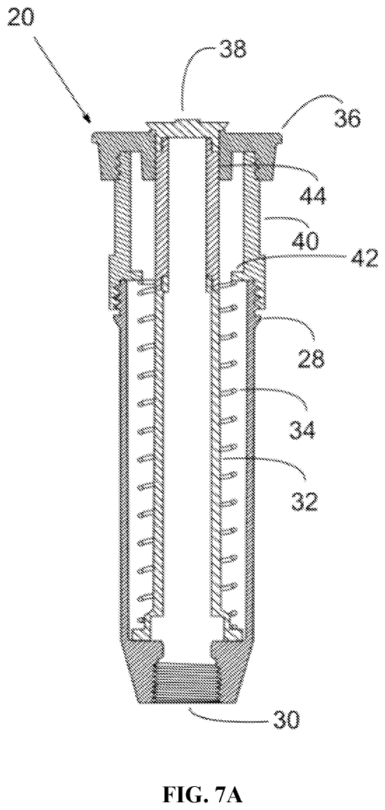

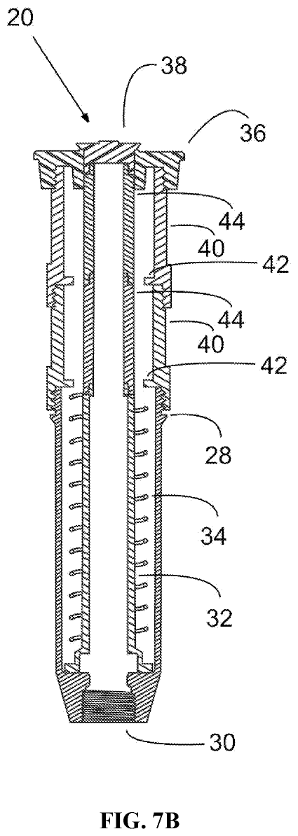

housing 28 contains riser 32 which is slidably or otherwise movably received within housing 28 between a retracted, non-operational position (as shown in FIG. 6 for prior art sprinkler head 10 and FIGS. 7A and 7B for disclosed sprinkler head 20) when the water pressure present in water line 22 fails to overcome the spring constant of spring 34 and an extended, operational position (as shown in FIG. 1 and FIG. 2 for prior art sprinkler head 10 and FIG. 3 for disclosed sprinkler head 20) when the water pressure present in water line 22 overcomes the spring constant of spring 34. Both housing 28 and riser 32 are generally hollow cylinders.

cap 36 is releasably joined to housing 28 by matching male and female threads found on cap 36 and housing 28. Centrally located within cap 36 is a cylindrical opening of a diameter slightly greater than the diameter of riser 32 wherethrough riser 32 passes when the water pressure present in water line 22 overcomes the spring constant of spring 34. The cylindrical opening is shown in FIG. 6 for prior art sprinkler head 10 and FIGS. 7A and 7B for disclosed sprinkler head 20. At the base of riser 32 is found a flange that has a diameter greater than the cylindrical opening thus preventing riser 32 from fully passing through cap 36.

Atop riser 32 is found nozzle 38, nozzle 38 is releasable joined to riser 32 by matching ale and female threads found on riser 32 and nozzle 38. Nozzle 38 has small openings to release water when pressure from water line 22 overcomes the spring constant of spring 34 and water passes from water line 22, into housing 28 and through riser 32. About the upper edge of nozzle 38 is found a flange that prevents nozzle 38 from passing through the cylindrical opening in cap 36 when the water pressure in water line 22 fails to overcome spring 34 spring constant.

housing 28 is generally a hollow cylinder with openings at both ends of the cylinder. The lower opening of housing 28 is releasably joined to threaded riser 26 by matching male and female threads while the upper opening of housing 28 is releasably joined to cap 36 by matching male and female threads, housing 28, on its internal walls, may contain one or more alignment features having the appearance of splines extending along the longitudinal length of housing 28 to engage matching alignment features found at the base of riser 32. These alignment features are not shown in this disclosure as they are not essential to the assembly being disclosed. Threaded riser 26, just as housing 28, is generally a hollow cylinder with openings at both ends of the cylinder that are threaded. As described above, the upper opening of threaded riser 26 is joined to matching threads found at the lower opening of housing 28 while the lower opening of threaded riser 26 is joined to matching threads found on tee junction 24. Water within water line 22 may freely pass-through tee junction 24 and threaded riser 26 into housing 28.

About riser 32 and within housing 28 is found spring 34, Spring 34 is bounded at its lower end by the flange found at the base of riser 32 and at its upper end by cap 36. When the pressure of the water in water line 22 is unable to overcome the force of spring 34 expansion, spring 34 will fully extend within housing 28 thus retracting riser 32 within housing 28 and nozzle 38 within cap 36. The close abutment of the walls of cap 36 with the walls of nozzle 38 will block the flow of any residual water out of the small openings present in nozzle 38. When the pressure of the water in water line 22 is able to overcome the expansion force of spring 34, spring 34 will collapse within housing 28 thus allowing riser 32 to extend upwards from housing 28 through cap 36. As long as the pressure of the water in water line 22 is able to overcome the expansion force of spring 34, water will rise through tee junction 24 through threaded riser 26 through housing 28 through riser 32 and out through the small openings in nozzle 38. This is depicted in FIGS. 1 and 2.

FIG. 1 shows prior art sprinkler head 10 when properly installed in soil 12. When properly installed, cap 36 is present at the surface of soil 12. If the water pressure in water e 22 is unable to overcome the expansion force of spring 34, riser 32 and nozzle 38 are retracted into housing 28, individuals walking on grass 16 atop of soil 12 need not be concerned about tripping over prior art sprinkler head 10. However, over time, new soil or other matter begins to accumulate over soil 12 and indirectly causes the surface of grass 16 to increase. Eventually, the deposit of accumulated soil 14 builds up to a point where the top of grass 16 is beyond the height of nozzle 38 and blocks the projection of water out of the small openings in nozzle 38 as shown in FIG. 2. At this point, maintenance personnel will have to dig around housing 28 to expose threaded riser 26. Replace threaded riser 26 with a similar but longer threaded riser 26 to again adjust the position of cap 36 so that it is present at the surface of accumulated soil 14. This is a difficult and time-consuming task and may cause the rupture of water line 22 if done too aggressively. To simplify this task, maintenance personnel may use the assembly disclosed herein without having to carefully dig about housing 28 to extend the height of housing 28 and riser 32 so that water may properly project from small openings in nozzle 38 onto grass 16 as shown in FIG. 3.

FIG. 4 shows an exploded view of prior art sprinkler head 10. The assembly and operation of prior art sprinkler head 10 has been fully discussed in the preceding paragraphs. FIG. 4 exists to clarify to the reader how the various components of prior art sprinkler head 10 may be brought together and assembled into a sprinkler head that is attached to a water line. Some components may be missing from FIG. 4 but these components are not necessary to the understanding of the assembly of the present invention.

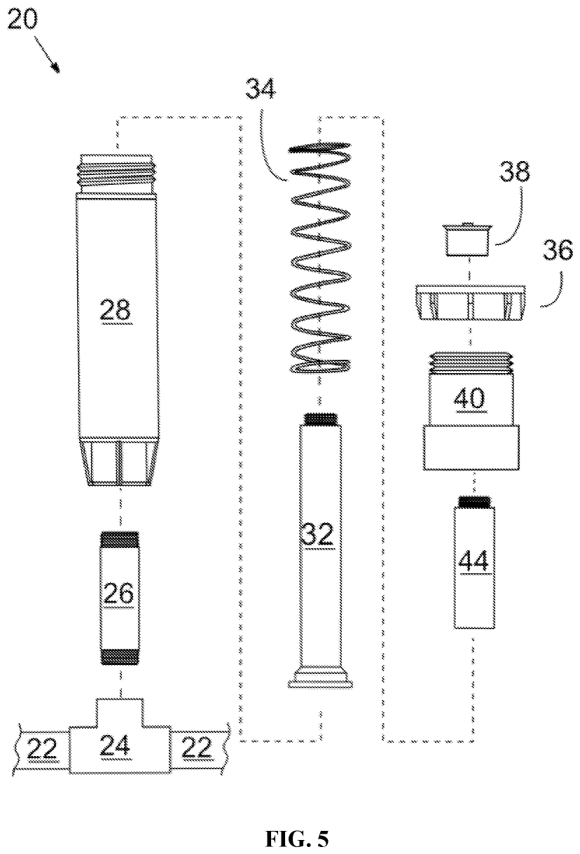

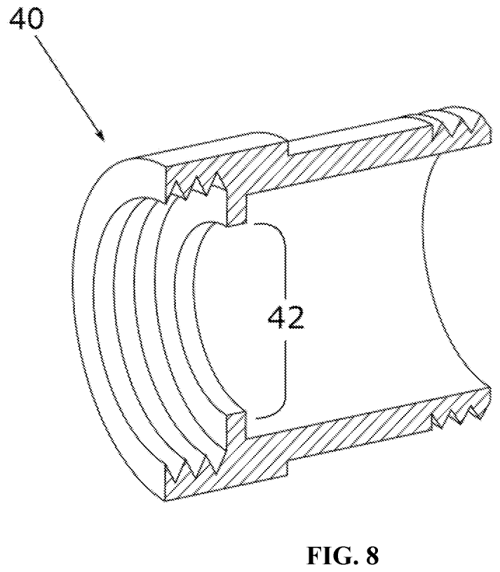

FIG. 5 shows an exploded view of disclosed sprinkler head 20. Disclosed sprinkler head 20 comprises all of the components of prior art sprinkler head 10 shown in FIG. 4 as well as two additional components: sleeve 40 and riser extension 44. Sleeve 40 is a hollow cylinder with a lower opening and an upper opening. The lower opening hosts threads that operably engage with threads atop of housing 28 while similarly the upper opening hosts threads that operably engage with threads found on cap 36. Likewise, riser extension 44 is a hollow cylinder with a lower opening and an upper opening. The lower opening hosts threads that operably engage with threads atop of riser 32 while similarly the upper opening hosts threads that operably engage with threads found on nozzle 38. Within sleeve 40 is found retaining ring 42, shown in FIGS. 7 and 8, that acts to limit the upper boundary of spring 34 just as cap 36 acted to limit the upper boundary of spring 34 in prior art sprinkler head 10. To modify prior art sprinkler head 10 with the assembly of the present invention, the maintenance personnel would first pull nozzle 38 out from cap 36 by overcoming the expansion force of spring 34 and unscrew nozzle 38 from riser 32. Second, cap 36 would be unscrewed from housing 28 exposing riser 32 and spring 34 within housing 28. Third, sleeve 40 would be screwed atop of housing 28. Fourth, riser extension 44 would be screwed atop of riser 32. Fifth, riser extension 44 would be pulled out of housing 28 by overcoming the expansion force of spring 34. While riser extension 44 is outside of housing 28, cap 36 is screwed atop of housing 28 and then nozzle 38 is screwed atop of riser extension 44. At this point the modification is complete and prior art sprinkler head 10 is now disclosed sprinkler head 20. Riser extension 44 may then be released and retracted back into housing 28 by spring 34. With sleeve 40 and riser extension 44 now attached, nozzle 38 may be lifted to a greater extent thus clearing grass 16 growing atop of accumulated soil 14. This modification may be done in far less time than when attempting to change threaded riser 26 of prior art sprinkler head 10 of the prior art by digging about prior art sprinkler head 10 as described above.

The length of sleeve 40 and riser extension 44 may be fabricated to raise nozzle 38 to different heights. Thus, consumers may purchase the assembly of the present invention to raise nozzle 38 by half an inch, an inch, or other such lengths. Additionally, threading or diameter on sleeve 40 and riser extension 44 may be varied to accommodate the threading or diameter used by the various manufacturers of sprinkler heads. Finally, sleeve 40 and riser extension 44 may be paired with additional sleeve 40 and riser extension 44 to further increase the height of nozzle 38.

FIG. 6 shows a sectional view of prior art sprinkler head 10 when assembled. FIGS. 7A and 7B shows a sectional view of disclosed sprinkler head 20 when assembled. These two figures demonstrate the assembly of the two sprinkler heads and is obvious to someone with ordinary skill in the art.

FIG. 8 shows a sectional isometric view of sleeve 40 to expose retaining ring 42. When sleeve 40 is joined to housing 28 retaining ring 42 limits the vertical movement of spring 34, performing a function similar to that of cap 36.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

1. An assembly to extend a sprinkler head that is mounted between the distal end of the sprinkler's housing and the proximal end of the sprinkler's cap the assembly comprising:
a sleeve in the form of a hollow cylinder with an internal surface and open proximal and distal ends said sleeve having:
a threaded first attachment means at its proximal end configured for attachment to the distal end of a sprinkler's housing,
a threaded second attachment means at its distal end configured for attachment to the proximal end of a sprinkler cap, and
a retaining ring protruding from said internal surface being proximate to said first attachment means; and
a riser extension in the form of a hollow cylinder with open proximal and distal ends having:
a threaded first attachment means at its proximal end configured for attachment to the distal end of a sprinkler's riser,
a threaded second attachment means at its distal end configured for attachment to the proximal end of a sprinkler's nozzle.

2. An assembly to extend a sprinkler head that is mounted between the distal end of the sprinkler's housing, or the distal end of a previously installed assembly, and the proximal end of the sprinkler's cap the assembly comprising:
a sleeve in the form of a hollow cylinder with an internal surface and open proximal and distal ends said sleeve having:
a threaded first attachment means at its proximal end configured for attachment to the distal end of a sprinkler's housing or to the distal end of a previously installed sleeve,
a threaded second attachment means at its distal end configured for attachment to the proximal end of a sprinkler cap, and
a retaining ring protruding from said internal surface being proximate to said first attachment means; and
a riser extension in the form of a hollow cylinder with open proximal and distal ends having:
a threaded first attachment means at its proximal end configured for attachment to the distal end of a sprinkler's riser or to the distal end of a previously installed riser extension,
a threaded second attachment means at its distal end configured for attachment to the proximal end of a sprinkler's nozzle.

3. The assembly of claim 1 wherein said internal surface of said sleeve is cylindrical.

4. The assembly of claim 2 wherein said internal surface of said sleeve is cylindrical.
